(19) United States
(12) Patent Application Publication
(10) Pub. No.: US 2015/0367679 A1
(43) Pub. Date: Dec. 24, 2015

(54) RAILCAR WHEEL, APPARATUS AND METHOD OF MANUFACTURE

(71) Applicant: RAIL 1520 IP LTD., Limassol (CY)

(72) Inventor: Vaughn W. Makary, Muskegon, MI (US)

(21) Appl. No.: 14/766,288

(22) PCT Filed: Dec. 4, 2014
(86) PCT No.: PCT/US14/68613

§ 371 Date: Aug. 6, 2015

Related U.S. Application Data
(60) Provisional application No. 61/912,888, filed on Dec. 6, 2013.

(51) Int. Cl. B60B 17/00; B22C 9/28; B22C 9/03

(52) U.S. Cl. CPC B60B 17/0006; B60B 17/0055; B22C 9/03; B22C 9/28

(57) ABSTRACT

A cast metal railroad car wheel includes a hub section, a tread section, and an uninterrupted annular web extending between and supporting the tread section on the hub section. The web includes a disk-shaped surface that is continuously concave and that does not include a reversely curved portion. A V-process casting process casts railroad wheels using a vacuum-process casting mold with opposing halves each partially filled with unbonded sand and sand-retaining-plastic film and a vacuum application port and that, when positioned together with the unbonded sand held to shape by vacuum and the film, define a cavity shaped to form a railroad car wheel. The V-process includes feeding molten metal into the cavity, cooling the molten metal, and releasing a vacuum to cause the sand to fall away from the railroad car wheel.

### BACKGROUND

The present invention relates railroad car freight wheels, and also to apparatus and casting methods for manufacturing the same. More particularly, the present invention relates to a novel railroad car freight wheel design, and also to a new apparatus and method/process for manufacturing the wheel using vacuum-sealed molding process casting technology. However, it is contemplated that the present innovation is not limited to only railroad wheels, nor limited to only the railroad industry.

Railroad car wheels have significant functional requirements, since they must survive and function safely in difficult environments, under substantial loads/stress, and often while being subjected to sharp impacts. Further, the product and amounts of products and freight they carry can be quite valuable, so any failure within a railcar wheel can be significant. As a result, railroad car wheels may have and be subject to many functional and durability requirements. Concurrently, railcar wheels are made from relatively large castings. Such large casting processes can make it difficult to provide defect-free castings having a quality that is sufficient for purposes of the railroad industry. As a result, despite previous improvements in design and manufacturing/casting techniques and processes, some consider that the basic technology for manufacturing railroad car wheels continues to be based primarily on conventional graphite casting techniques using fundamentally old technology.

In particular, it has been long believed in the railroad industry that an “all sand” mold cannot make railcar wheels. This is partially because most industry experts believe that casting defects, such as inclusion-type defects believed to be inherent in the sand-casting process, made the process uneconomical due to the cost of rework and due to the difficulty of casting the high carbon material used in railcar wheels. The standard “all-silica” sand molds do not promote the rapid solidification of the wheel tread and feed risers as needed. Concurrently, a “standard all sand” mold is not completely stable, making accurate placement of inserts and heat sinks unfeasible, and making highly accurate castings and “directionally cooled” castings extremely difficult.

Known railroad car wheels are cast using “graphite casting” techniques, where bound sand and/or permanent molds are used to receive molten metal for cooling. For example, see Beetle U.S. Pat. Nos. 3,302,919 and 3,480,070. However, known processes, including those using graphite casting techniques, have limitations in terms of costs, very high scrap rates, secondary steps that require considerable processing time and effort and cost, and other limitations. For example, one limitation is that, due to the complicated mechanical process of filling the graphite mold and the size requirements of graphite molds, it is very difficult and/or cost prohibitive to increase the number of cavities in a graphite mold. It is desired to improve upon these methods by providing a system that reduces costs, reduces scrap rates, reduces secondary steps and other influencers of cost, and to generally reduce the cost and time required per wheel produced. Attempts, to date, have not been commercially successful.

Vacuum-sealed molding processes (commonly called “V-processes” or “V-process casting” herein) for casting materials are known. For example, Workman U.S. Pat. No. 4,100,958 discloses basic information about V-processes, including the use of thin plastic film on unbonded sand combined with vacuum to temporarily hold the sand. However, V-processes also have limitations in terms of parameters that are required to minimize scrap, difficulty in reliably holding sand shapes in the V-molding casting process, and the need for several specialized components not usually associated with casting processes (such as the thin plastic film, the unbonded sand, and vented molds). As a result, V-process casting has never been used to manufacture railroad car wheels.

### SUMMARY OF THE PRESENT INVENTION

According to a first aspect of the present invention, a cast metal railroad car wheel includes a hub section having an axle bore, a tread section with an axially-extending edge flange, and an uninterrupted annular web that extends between and supports the tread section on the hub section. The web includes opposing disk-shaped surfaces, wherein at least one of the opposing disk-shaped surfaces defines a substantially concave surface that is free of a reversely curved portion.

A second aspect of the present invention is a cast metal railroad car wheel including a hub section, and a tread section with an axially-extending flange that is concentric with and laterally offset from the hub section. An annular web extends from the hub section to the tread section, where the annular web supports the tread section on the hub section. The annular web includes opposing disk-shaped surfaces, wherein at least one of the disk-shaped surfaces is shaped such that a cross section of the annular web taken perpendicular to the annular web defines a concave curve of the at least one disk-shaped surface. The concave curve of the at least one disk-shaped surface includes a radius of less than 35 millimeters. The at least one disk-shaped surface is free of a reversely-curved portion.

Embodiments of the second aspect of the invention can include any one or a combination of the following features:
The radius of the at least one disk-shaped surface includes a radius of less than 25 millimeters;
The at least one disk-shaped surface includes a radius of less than about 15 millimeters.

A further aspect of the present invention is a process for casting a cast metal railroad car wheel. The method includes providing a V-process casting mold with opposing halves, where each opposing half includes unbonded sand adjacent a sand-retaining plastic film having a vacuum application port, and wherein the opposing halves, when positioned together with the unbonded sand held to shape by application of a vacuumed film, define a cavity shaped to form a railroad car wheel having a hub section with an axle bore, a tread section with an axially-extending edge flange and an uninterrupted annular web extending between and supporting the tread section on the hub section. The method also includes providing a fill passage in one of the opposing halves. The method further includes infeeding molten metal through the fill passage and into the cavity. Further, the method includes cooling the molten metal to maintain a shape of the cavity and thus form a cast metal railroad car wheel. The method also includes releasing a vacuum to cause the unbonded sand to fall away from the cast metal railroad car wheel.

Embodiments of this further aspect of the invention include any one or a combination of the following features:
The fill passage is positioned over the hub section, and includes a tube-defining plastic riser leading to a filter that strains in-fed molten metal being motivated through the plastic riser into the cavity;
The in-fed molten metal is fed through the fill passage at a rate of from approximately 45 kilograms per second to approximately 50 kilograms per second;
The in-fed molten metal fed through the fill passage has a temperature within the range of approximately 2,900 degrees Fahrenheit to about 2,825 degrees Fahrenheit;
The in-fed molten metal fed through the fill passage has a temperature within the range of about 2,850 degrees Fahrenheit to about 2,825 degrees Fahrenheit;
The in-fed molten metal fed through the fill passage has a temperature of about 2,825 degrees Fahrenheit;
The step of releasing the vacuum causes the unbonded sand to fall away solely by the force of gravity.

A further aspect of the present invention is a process for casting multiple cast metal railroad car wheels simultaneously. The process includes providing a cast mold with opposing halves, each at least partially filled with sand and that, when positioned together with the sand, define a plurality of cavities each shaped to form a railroad car wheel having a hub section with an axle bore, a tread section with an axially-extending edge flange, and an uninterrupted annular web extending between and supporting the tread section on the hub section. The method also includes providing a fill passage leading into each of the cavities for communicating in-fed molded metal. Also, the process includes infeeding molten metal through the fill passages and through a filter into the cavities. Further, the process includes cooling the molten metal to simultaneously form a plurality of cast metal railroad car wheels.

Embodiments of this further aspect of the invention can include any one or a combination of the following features:
The process for casting comprises a vacuum-casting mold process that includes sand disposed at least partially within a sand-retaining-plastic film and a vacuum application port, and where the sand is unbonded sand;
The in-fed molten metal is fed through the fill passage at a rate of from approximately 45 kilograms per second to approximately 50 kilograms per second;
The in-fed molten metal fed through the fill passage has a temperature within the range of approximately 2,900 degrees Fahrenheit to about 2,825 degrees Fahrenheit;
The in-fed molten metal fed through the fill passage has a temperature within the range of about 2,850 degrees Fahrenheit to about 2,825 degrees Fahrenheit;
The in-fed molten metal fed through the fill passage has a temperature of about 2,825 degrees Fahrenheit.

A further aspect of the present invention is a process for casting a cast metal railroad car wheel. The process includes providing a V-process casting wheel with opposing halves, each at least partially filled with unbonded sand, and having sand-retaining-plastic film and a vacuum application port and that, when positioned together with the unbonded sand held to shape by a vacuum and the film, define a cavity shaped to form a railroad car wheel having a hub section with axial bore, a tread section with an axially-extending edge flange, and an uninterrupted annular web extending between and supporting the tread section on the hub section. The process also includes providing a fill passage in one of the opposing halves leading to the hub section, the fill passage including a ceramic tube for directing flow of in-fed molten metal being motivated into the cavity. Additionally, the process includes infeeding molten metal through the fill passage and through a filter into the cavity. The method also includes cooling the molten metal to maintain a shape of the cavity and thus forming a cast metal railroad car wheel. Further, the method includes releasing a vacuum to cause the same to fall away by gravity from the cast metal car wheel.

Embodiments of this further aspect of the invention can include any one or combination of the following features:
The fill passage extends to a location under a bottom of the hub section;
The in-fed molten metal is fed through the fill passage at a rate of from approximately 45 kilograms per second to approximately 50 kilograms per second;
The in-fed molten metal fed through the fill passage has a temperature within the range of approximately 2,900 degrees Fahrenheit to about 2,825 degrees Fahrenheit;
The in-fed molten metal fed through the fill passage has a temperature within the range of about 2,850 degrees Fahrenheit to about 2,825 degrees Fahrenheit;
The in-fed molten metal fed through the fill passage has a temperature of about 2,825 degrees Fahrenheit.

A further aspect of the present invention is a process for casting a cast metal railroad wheel. The process includes providing a V-process casting mold with opposing halves, each at least partially filled with unbonded silica sand and having sand-retaining-plastic film and a vacuum application port, and that, when positioned together with the unbonded sand, held to shape by vacuum and the film, define a cavity shaped to form a railroad car wheel having a hub section with axial bore, a tread section with an axial-extending edge flange, and an uninterrupted annular web extending between and supporting the tread section on the hub section. The method also includes providing a fill passage in one of the opposing halves leading to the hub section. Also, the method includes feeding molten metal through the fill passage and through the filter into the cavity, where the molten metal is fed at a temperature of less than about 2,850 degrees Fahrenheit. Additionally, the method includes cooling the molten metal to maintain a shape of the cavity and thus form a cast metal car wheel. Further, the method includes releasing a vacuum to cause the sand to fall away from the cast metal railroad car wheel.

Embodiments of this further aspect of the invention can include any one or a combination of the following features:
The temperature of the molten metal being fed into the cavity is less than about 2,800 degrees Fahrenheit;
The molten metal is fed into the cavity at a rate of at least about 50 kilograms per second;
The molten metal is fed into the cavity at a temperature that is less than about 150 degrees Fahrenheit from the metal's solidification temperature;
The method includes the step of releasing the vacuum to cause the unbonded sand to fall away by the force of gravity, and wherein the unbonded sand is unbonded silica sand.

Another aspect of the present invention is a process for casting a metal railroad car wheel. The process includes providing a V-process casting mold with opposing halves, each at least partially filled with unbonded sand and having a sand-retaining-plastic film and a vacuum application port and that, when positioned together with the unbonded sand, held to shape by a vacuum and the sand-retaining-plastic film, define a cavity shaped to form a railroad car wheel having a hub section with an axial bore, a tread section with an axial-extending edge flange, and an uninterrupted annular web extending between and supporting the tread section on the hub section. The process also includes providing a fill passage in one of the opposing halves and providing a vent-forming material touching the tread section of the cavity, the vent-forming material being one of a tubular shape and a porous material. The process also includes infeeding molten metal through the fill passage and into the cavity while venting through the vent-forming material. Additionally, the process includes cooling the molten metal to maintain the shape of the cavity and thus forming a cast metal railroad car wheel. Further, the process includes releasing a vacuum to cause the sand to fall away by gravity from the cast metal railroad car wheel.

Embodiments of this further aspect of the invention can include any one or combination of the following features:
The vent-forming material defines a tubing extending from the tread section;
The vent-forming material includes a particulate material different than the unbonded sand;
The vent-forming material is a cast-cooling accelerator that defines a predetermined cooling pattern within the cavity;
The predetermined cooling pattern within the cavity is defined by cooling the tread section before the annular web and hub section.

A further aspect of the present invention is a process for casting a cast metal railroad car wheel. The process includes providing a V-process casting mold with opposing halves, each at least partially filled with unbonded sand and having sand-retaining-plastic film and a vacuum application port and that, when positioned together with the unbonded sand held to shape by a vacuum and the sand-retaining-plastic film, define a cavity shaped to form a railroad car wheel having a hub section with an axle bore, a tread section with an axially-extending edge flange, and an uninterrupted annular web extending between and supporting the tread section on the hub section. The method also includes providing a fill passage in one of the opposing halves and providing a cast-cooling-accelerator material touching the tread section of the cavity. The process also includes infeeding molten metal through the fill passage and into the cavity. Additionally, the process includes cooling the molten metal to maintain a shape of the cavity and thus form a cast metal railroad car wheel, including accelerating the cooling of the cast metal railroad car wheel via the cast-cooling accelerator material. Further, the process includes releasing the vacuum to cause the sand to fall away by gravity from the cast metal railroad car wheel.

Embodiments of this further aspect of the invention can include any one or a combination of the following features:
The cast-cooling accelerator material includes particulate material selected from a group consisting of one of zircon and chromite media that promotes faster cooling of the tread section than that of the hub section and annular web;
The in-fed molten metal is fed through the fill passage at a rate of from approximately 45 kilograms per second to approximately 50 kilograms per second;
The in-fed molten metal fed through the fill passage has a temperature within the range of approximately 2,900 degrees Fahrenheit to about 2,825 degrees Fahrenheit;
The in-fed molten metal fed through the fill passage has a temperature within the range of about 2,850 degrees Fahrenheit to about 2,825 degrees Fahrenheit;
The in-fed molten metal fed through the fill passage has a temperature of about 2,825 degrees Fahrenheit.

A further aspect of the present invention is a process for casting a railroad wheel. The process includes providing a V-process casting mold including unbonded sand defining at least one cavity shaped to form a railroad car wheel. The process also includes filling the cavity with molten metal. Further, the process includes cooling the molten metal to thus form a metal railroad car wheel casting.

Embodiments of this further aspect of the invention can include any one or a combination of the following features:
The mold includes a plurality of cavities;
The molten metal has a temperature of less than about 2,800 degrees Fahrenheit;
The molten metal is fed at a rate of at least about 50 kilograms per second;
The molten metal is fed at a temperature that is less than about 150 degrees Fahrenheit from the metal's solidification temperature;
The mold includes a fill passage positioned over a hub section of the wheel, and includes a tube-defining plastic riser leading to a filter that strains infed molten metal being motivated through the plastic riser into the cavity;
The mold includes a ceramic tube defining at least a portion of the fill passage into the wheel.

A further aspect of the present invention is a cast metal railroad wheel that includes a hub section with an axle bore, a tread section with an axially-extending edge flange, and an uninterrupted annular web extending between and supporting the tread section on the hub section. The annular web includes opposing disk-shaped surfaces. At least one of the disk-shaped surfaces, when cross-sectioned through the hub and tread sections, defines a cross-sectional shape having a radius of less than 35 millimeters.

Embodiments of this further aspect of the invention can include any one or a combination of the following features:
Wherein the radius is less than 25 millimeters;
Wherein the radius is less than about 15 millimeters.

These and other features, advantages and objects of the present invention will be further understood and appreciated by those skilled in the art by reference to the following specification, claims and appended drawings.

### BRIEF DESCRIPTION OF DRAWINGS

In the drawings:

FIG. 1 is a cross-sectional view of a novel railroad car wheel embodiment of the present invention and showing only the material of the cross-sectioned plane;

FIG. 2 is a cross-sectional view of the novel railroad car wheel of FIG. 1 and including the background material of the cross-sectioned wheel;

FIG. 3 is an enlarged cross-sectional view of the railroad car wheel of FIG. 1 taken at area III;

FIG. 4 is a cross-sectional view of an alternate configuration of a railroad car wheel formed using embodiments of the V-process;

FIG. 5 is a cross-sectional view of another alternate configuration of a railroad car wheel formed using an embodiment of the V-process;

FIG. 6 is a cross-sectional view of a prior art railroad car wheel overlaid on the railroad car wheels, shown in dashed line, of FIGS. 4 and 5;

FIG. 7 is a cross-sectional view of the full railroad car wheel of the embodiment shown in FIG. 5 overlaid on the prior art railroad car wheel of FIG. 6, shown in dashed line, for comparative purposes;

FIG. 8 is a cross-sectional view of an embodiment of the V-process mold;

FIG. 9 is an enlarged cross-sectional view of the V-process mold of FIG. 8;

FIG. 10 is a cross-sectional view of an alternate embodiment of a V-process mold according to the present invention;

FIG. 11 is an enlarged cross-sectional view of the V-process mold of FIG. 10;

FIG. 12 is a cross-sectional view of another alternate embodiment of a V-process mold, according to the present invention;

FIG. 13 is an enlarged cross-sectional view of the V-process mold of FIG. 12;

FIG. 14 is a cross-sectional view of another embodiment of the V-process mold according to the present invention;

FIG. 15 is an enlarged cross-sectional view of the V-process mold of FIG. 14;

FIG. 16 is a cross-sectional view of another alternate embodiment of the V-process mold according to the present invention;

FIG. 17 is an enlarged cross-sectional view of the V-process mold of FIG. 16;

FIG. 18 is a cross-sectional view of another alternate embodiment of a V-process mold, according to the present invention;

FIG. 19 is a cross-sectional view of another alternate embodiment of a V-process mold, according to the present invention;

FIG. 20 is a cross-sectional view of another alternate embodiment of a V-process mold, according to the present invention;

FIG. 21 is a cross-sectional view of an embodiment of a multi-cavity V-process mold including top and bottom die halves held together with unbonded sand therein and including a J-shaped bottom-feeding ceramic tile gating and an over-hub top one-piece riser form, according to the present invention; and

FIG. 22 is a schematic flow diagram illustrating a method for casting a cast-metal railroad car wheel using a V-process casting mold.

### PRIOR ART

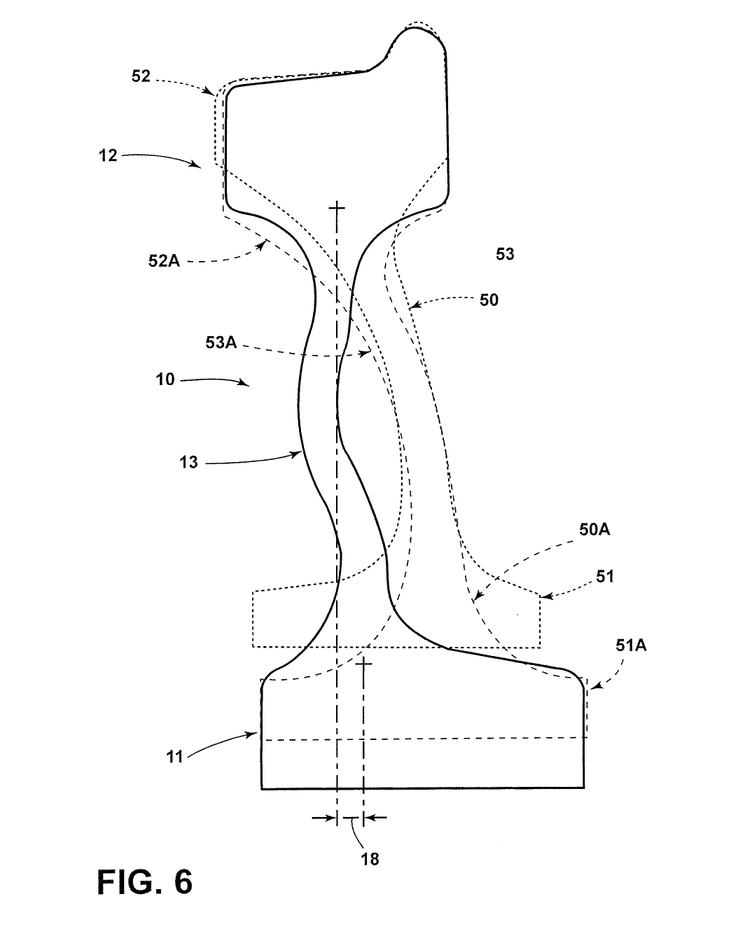

A prior art railroad car wheel 10 (FIG. 6, shown compared to novel railroad car wheels 50, 50A) includes a hub 11, a tread 12, and a multiply-curved “S-shaped” web 13 extending between and supporting the tread 12 on the hub 11. The illustrated multi-curved web 13 has a traditional S-shape (i.e., with reversely curved portion) that is intended to allow the web 13 to structurally support the tread 12 on the hub 11 without the web 13 causing the tread 12 and/or hub 11 to distort. In particular, the multiple curves are designed to allow the web 13 to expand (or contract) from heat generated (or lost) during use (such as braking or loading or travel conditions), and to expand (or contract) from heat received (or heat lost) from its ambient environment, without forcing distortion of the tread 12. Also, the web 13 engages the hub 11 and the thread 12 in approximately the same vertical plane such that the offset 18 is minimized. The structural integrity and dimensional requirements of the hub 11, tread 12, and web 13 are set by standards and are closely controlled so that the wheel 10 does not distort out of shape during use, despite temperature fluctuations and significant loading.

### DETAILED DESCRIPTION OF PREFERRED EMBODIMENTS

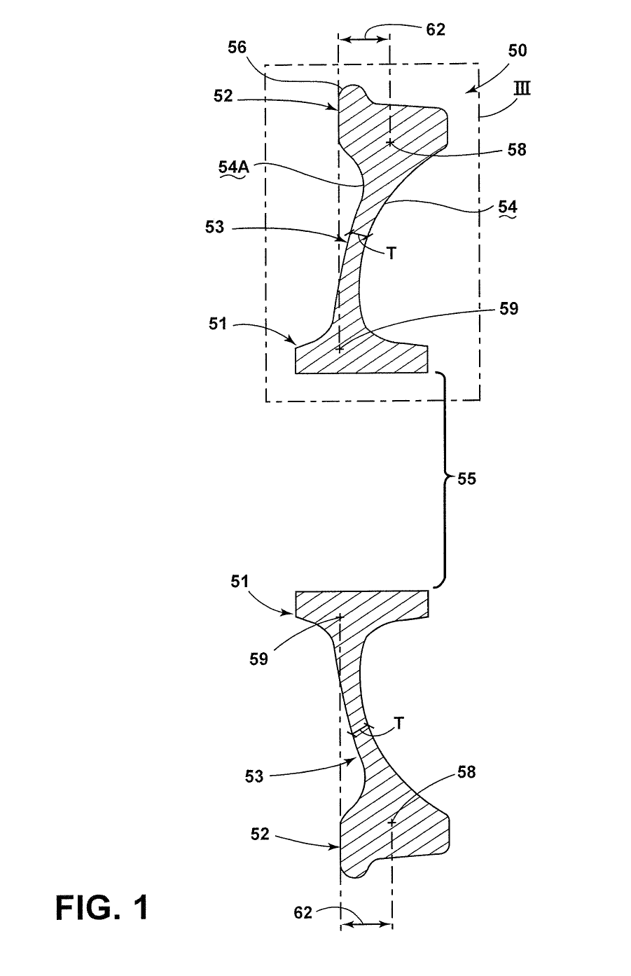

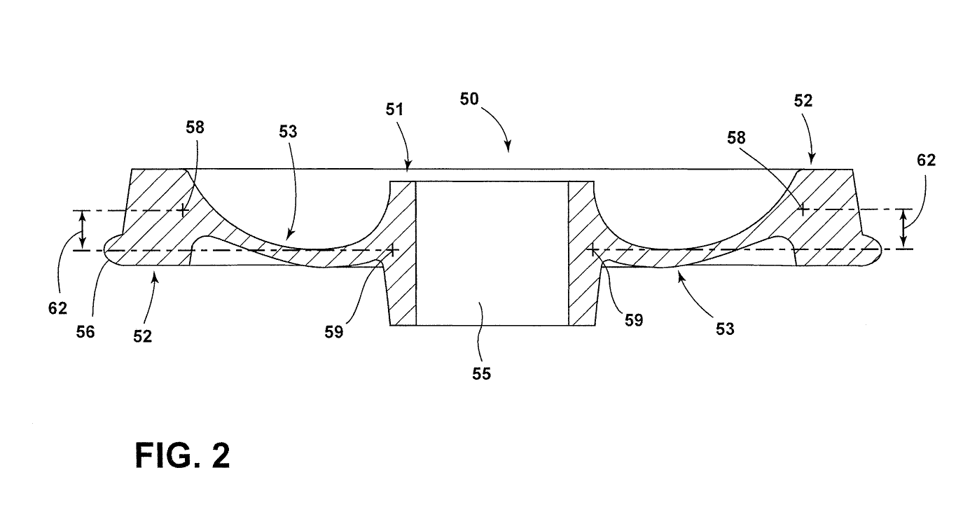

The present cast metal railroad car wheel 50 (FIGS. 1-2) includes a hub section 51, a tread section 52, and an uninterrupted annular web 53 (sometimes called a “rib”) extending between and supporting the tread section 52 on the hub section 51. As will be understood by persons skilled in this art, the present innovative railroad car wheel 50 is designed to meet all railroad wheel requirements, including hub, tread and web functional/structural requirements. The illustrated web 53 includes opposing disk-shaped surfaces 54, and 54A.

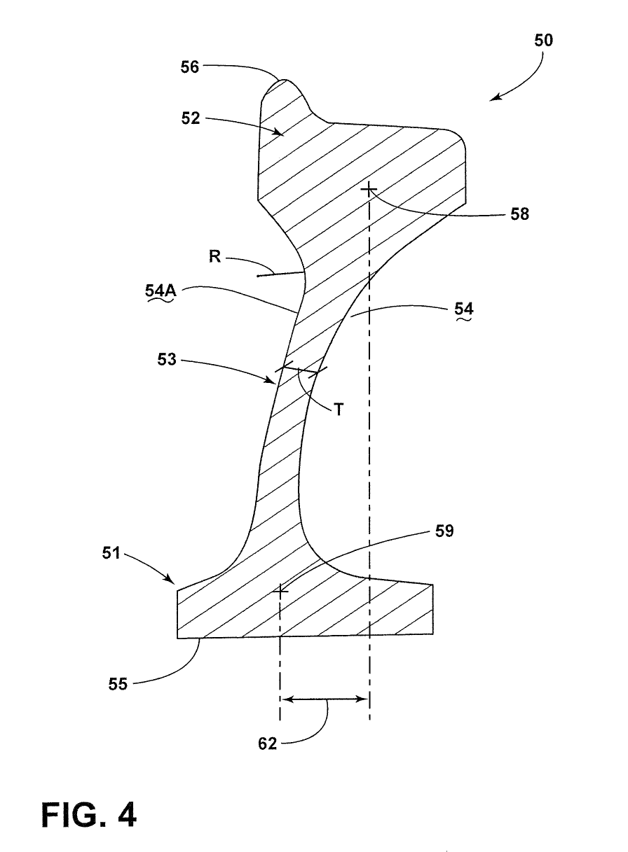

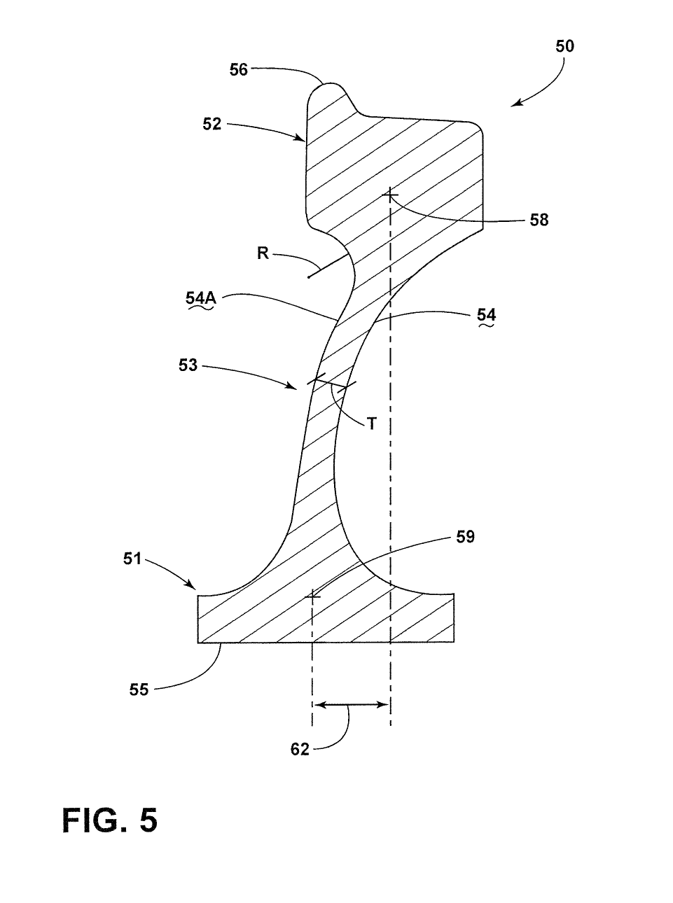

Referring to FIGS. 1-5, the disk-shaped surface 54, when cross sectioned through the hub and tread sections 51, 52, defines a cross-sectional shape that is continuously concave and that does not include a reversely curved portion. More broadly, the web 53 is designed to have a continuous sweep, and not a “multi-bent” curve (as shown in FIG. 6). Notably, a shape of the illustrated web 53, when heated, will bulge in an outward direction (i.e. on the side surface 54A), thus relieving stress from heat while continuing to allow the web 53 to functionally support the hub 51 and tread 52. Notably, this wheel 50, having a non-reversely-curved web 53, is much easier to cast than the traditional prior art wheel 10 (having a reversely-curved S-curved web 13, shown in FIG. 6). Additionally, based upon testing, the wheel 50 meets or exceeds the functional strength and other properties as required for railroad car wheels. Further, it is contemplated that the amount of the curvature included in wheel 50 can be increased when using the V-process casting. For example, the illustrated curvature of web 53 has a thickness T along the mid-section of the web 53.

Additionally, as illustrated in FIGS. 1-5, the curvature of the web 53 includes an offset 62 between a tread-side middle point 58 and a hub-side middle point 59. According to the various embodiments, the offset 62 can be a distance of about 1.5 times the thickness T. It is contemplated that the offset 62 can be up to about 20 times the thickness T, or more. Other offset 62 distances are contemplated that may be less than 1.5 times the thickness T or more that is 20 times the thickness T. In the various embodiments, the amount of curvature in the web 53 determines the amount of offset 62 between the tread-side middle point 58 and the hub-side middle point 59 of the web 53. The amount of offset 62 implemented for a particular railcar wheel design is determined by several factors, including, but not limited to, the functional and structural requirements of a particular wheel design.

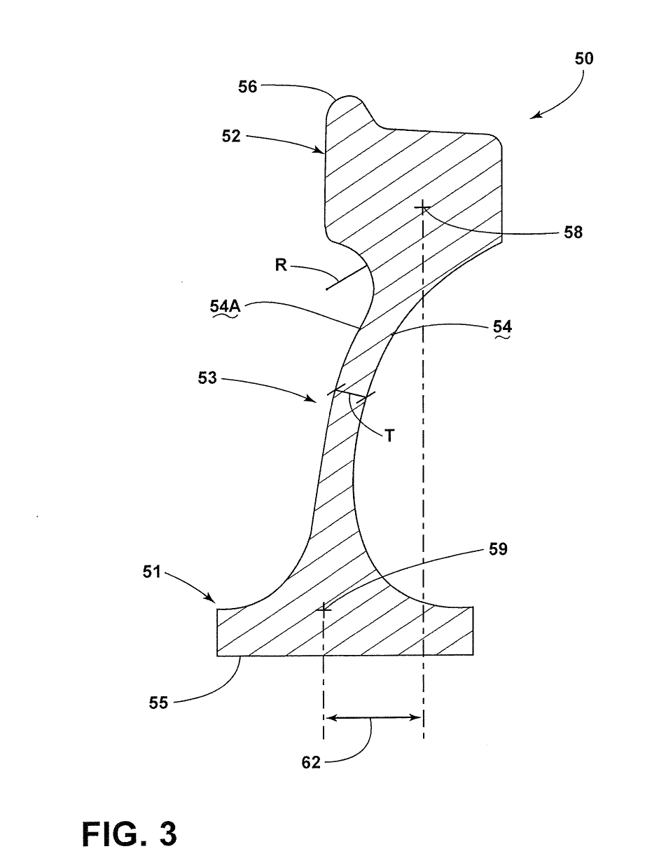

Referring again to FIGS. 3-5, the railroad car wheel 50 includes a web 53 that defines with the tread 52 a relatively sharp radius R on the surface 54A side of the web 53 between the web 53 and the tread 52. It is contemplated that the radius can be less than a 35 millimeters radius, or even less than 25 millimeters, or even as low as 15 millimeters. Notably, a radius of less than 35 millimeters is possible in V-process casting. However, such a radius is very difficult, if not impossible, to achieve via a conventional graphite casting process. The capability of casting a radius of 15 millimeters provides significant advantages and capabilities in terms of railroad wheel design and construction. Relatively small radii of curvature R are possible within other portions of the railroad car wheel 50 using the various embodiments of the V-process casting.

A significant part of the present innovation is the use of a vacuum-process (“V-process”) casting to cast railroad wheels. V-process casting is known, and is described in various publically available ways, for example, Workman U.S. Pat. No. 4,100,958, the disclosure of which is incorporated herein in its entirety for its teachings.

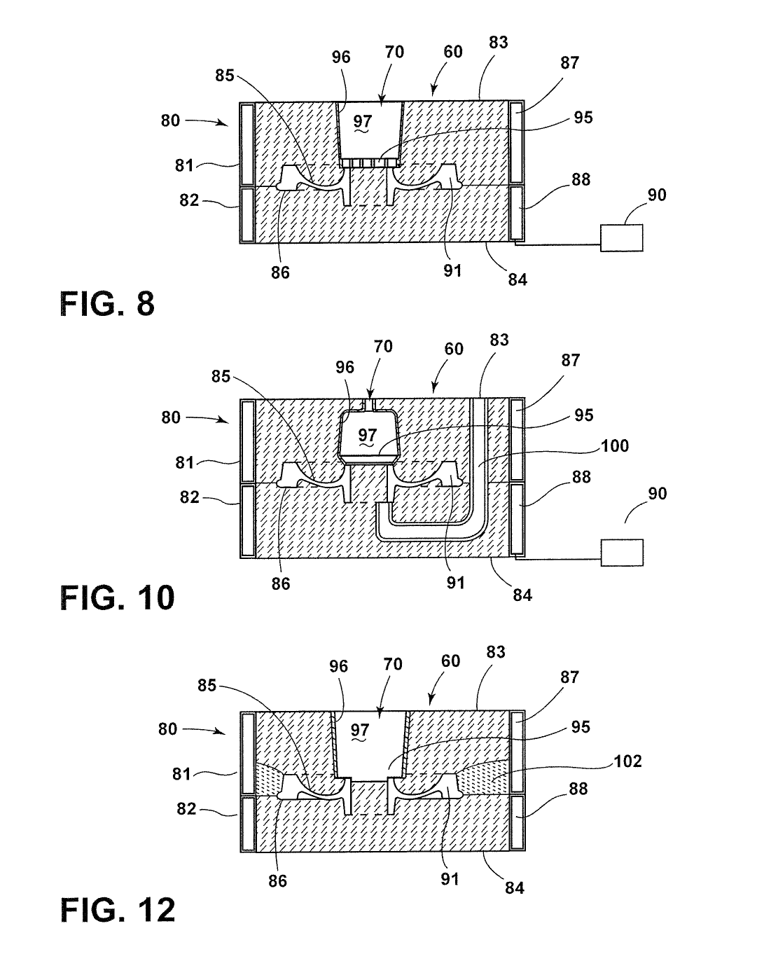

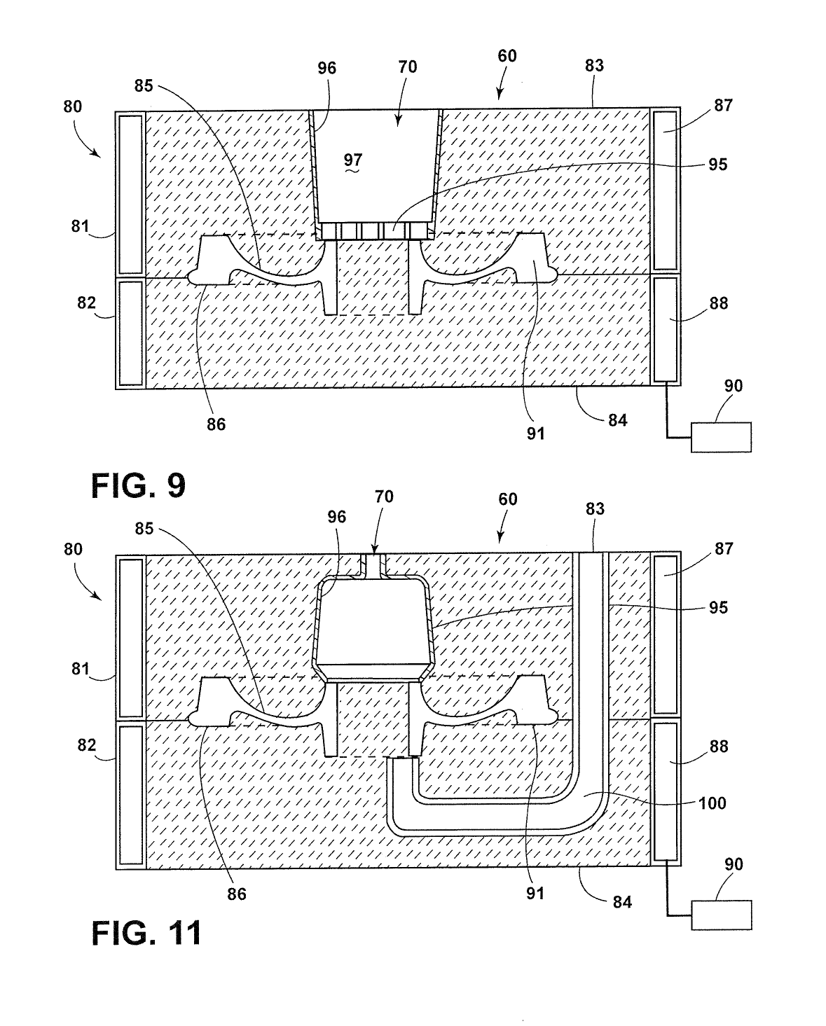

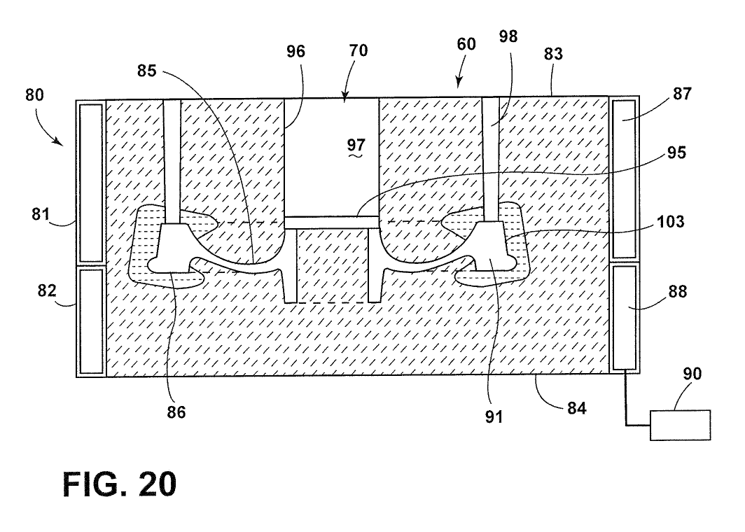

A vacuum-sealed molding process (V-process), illustrated in FIGS. 8-21, for casting of materials in the present innovation includes formation of sand molds 60 in the absence of a pattern plate and with cores supported in the mold by suction. A handling apparatus for producing the mold uses a vibratory vacuum table that incorporates a pneumatic sand transfer apparatus delivering a predetermined quantity of sand to the mold box. Notably, the V-process differs from conventional molding processes in that there is no requirement to use an organic binder material mixed with the sand grains. Thus, the unbonded sand can be reused without reprocessing. The mold boxes in the present V-process require perforated hollow walls and are pressurized to sub-atmospheric pressure (hence the term “vacuum”) to enable the molded shape of a railroad car wheel 50 to be maintained through the use of unbonded sand.

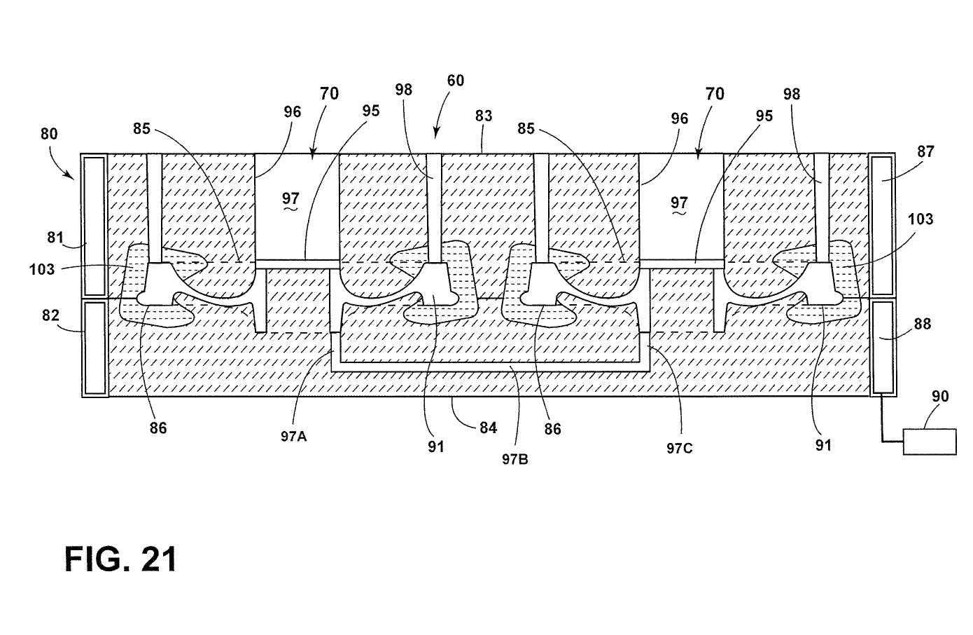

Due to a compact size and other characteristics of V-process casting, as described hereafter, it is contemplated that molds can be multi-cavity (shown in FIG. 21), which increases production tremendously (e.g., by providing 2 to 4 times the parts per mold cycle depending on number of cavities). Also, the V-process casting provides a better solidification pattern on the wheel since the molten metal 70 is poured closer to the solidification temperature. As a result of the V-process casting, the railroad car wheel 50 is released from the V-process casting mold 80 much sooner, both due to being poured closer to the solidification temperature and also due to a speed of removing sand (which falls away when vacuum is released). Notably, the hub section 51 of the V-process cast railroad car wheel 50 also eliminates much of the heat in the hub section 51 of the wheel, which allows a much better yield per unit of cast material (i.e. in terms of the metal poured versus wheel weight).

One optional feature that may be used in the V-process casting process is the use of argon shrouding to reduce oxygenation and micro porosity. Notably, micro porosity is one of the most critical factors in a life cycle of a railroad wheel. Oxygenation (occurring due to the presence of oxygen) can be problematic when molten metal 70 is held in a melting pot, and/or when molten metal 70 is being poured. By using argon shrouding, oxygenation is reduced, leading to less micro porosity. Argon gas can be used to assist by reducing a presence of oxygen. Other shrouding gases can include, but are not limited by, nitrogen, other inert gases, combinations thereof, and others. Notably, V-process casting processes naturally reduce oxygenation due to a lower temperature of the molten metal 70. Shrouding can be used to further improve a quality of castings, which can be important in railroad wheels, due to their size and due to safety/functional regulations.

The V-process utilizes a pattern secured to a carrier box, with a number of narrow passageways leading from the hollow interior of the carrier box to the surface of the pattern. A heated plastic film 85 (about 0.01 millimeters thick) is draped over the pattern and caused to cling to the surface thereof by reducing the pressure in the interior of the carrier box to sub-atmospheric/vacuum (by connection to a suction pump). A mold box in the form of the V-process casting mold 80 is located around the periphery of the pattern and loaded with unbonded sand 83 which is compacted by vibration. A further heated plastic film 86 is placed on the exposed surface of the body of sand which is then subjected to sub-atmospheric pressure by virtue of a vacuum source 90, such as a suction pump, being connected to the mold box which has a perforated wall in contact with the body of sand. With this body of sand maintained at a sub-atmospheric pressure (of about 0.5 atmospheres) the shape of the sand mold 60 is maintained in a hard condition and can be removed from the pattern. Upper and lower mold halves 81, 82 produced in this manner can be subjected to pouring of molten metal 70 immediately after the opposing mold halves 81, 82 are brought together and the sub-atmospheric pressurizing of the two sand molds 60 is maintained until the cast molten metal 70 has cooled sufficiently to be released.

The various embodiments of the V-process casting, as illustrated in FIGS. 8-21, uses a vacuum-process casting mold 80 with opposing halves 81, 82 each partially filled with unbonded sand 83, 84, and sand-retaining-plastic film 85, 86 and a vacuum application port 87, 88. When positioned together, the unbonded sand 83, 84 is held to shape in the form of the sand molds 60 by a vacuum applied via vacuum source 90 and by the film 85, 86. The film 85, 86 holds the sand 83, 84 to define a cavity 91 shaped to form one or more of the railroad car wheels 50. The V-process includes feeding molten metal 70 into the cavity 91, cooling the molten metal 70 to form a railroad car wheel 50, and releasing a vacuum to cause the unbonded sand 83, 84 to fall away from the V-process cast railroad car wheel 50. The unbonded sand can fall away by the force of gravity or can be made by various apparatuses, or by hand. It is noted that the V-process mold 80 has small sand grains and no additives so it is very mechanically and thermally stable. This contrasts with standard all sand molds with bonded sand, which bonded sand is not completely stable.

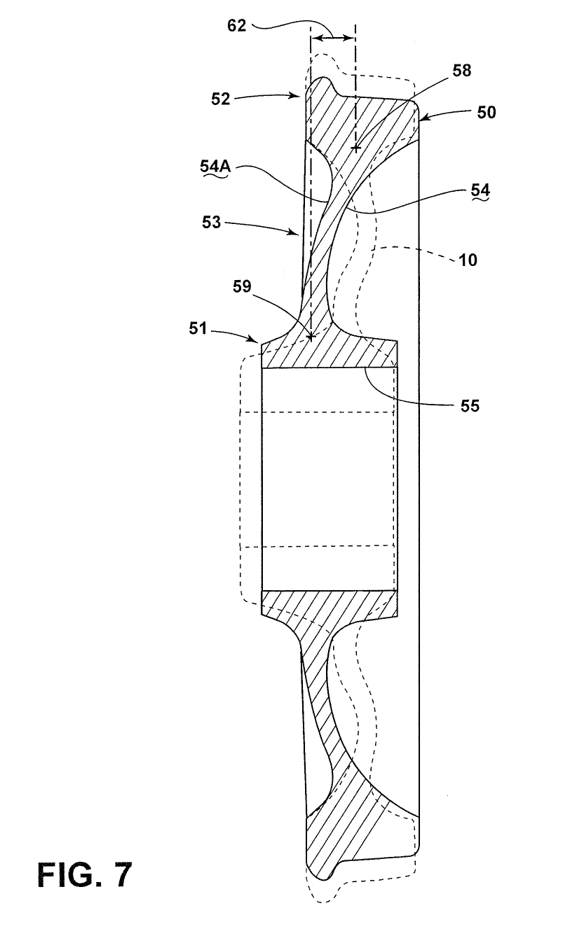

As illustrated in FIGS. 1-5 and 7, the resulting cast metal railroad car wheel 50 comprises a hub section 51 with axle bore 55, a tread section 52 with an axially-extending edge flange 56, and an uninterrupted annular web 53. The web 53 is disk-shaped, and has a relatively constant thickness along its length, with increasing thickness as the web 53 approaches the hub and tread sections 51, 52. The web 53 defines opposing disk-shaped surfaces 54 and 54A. It is noted that with web 53, the disk-shaped surface 54, when cross sectioned through the hub and tread sections 51, 52 defines a cross-sectional shape that is continuously concave and that does not include a reversely curved portion.

It is noted that while certain specific dimensional details of the web 53 (including the hub section 51, the tread section 52 and the web 53, including thickness and details of the sweep) are included herein, such details are not necessary for an understanding of the present invention by a person skilled in the art of railroad car wheel design. The dimensions and structural strengths are important, but particular dimensions are not needed for an understanding. For example, as illustrated in FIG. 6, in the embodiment shown in dotted lines, it is noted that the wheel 50A includes a hub section 51A, tread section 52A and web section 53A that are not unlike the wheel 50. A comparison of specific shapes can be seen by comparing the dotted lines and dashed lines showing two alternative configurations of railroad car wheels 50 forward using embodiments of the V-process casting. Additionally, while the benefits of the railroad car wheel 50, 50A having a non-reversely curved web are discussed herein, the embodiments of the V-process casting can be used to cast railcar wheels having various alternate geometries, including railcar wheels having a reversely-curved S-curved web, other multi-curved webs, or other shapes and configurations.

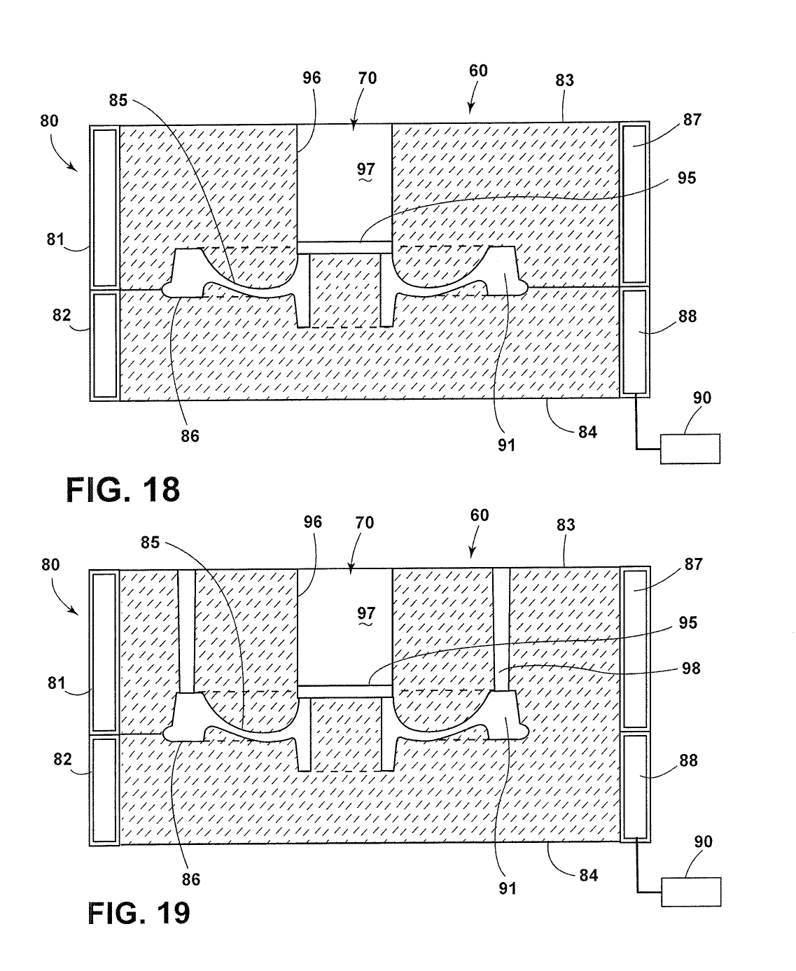

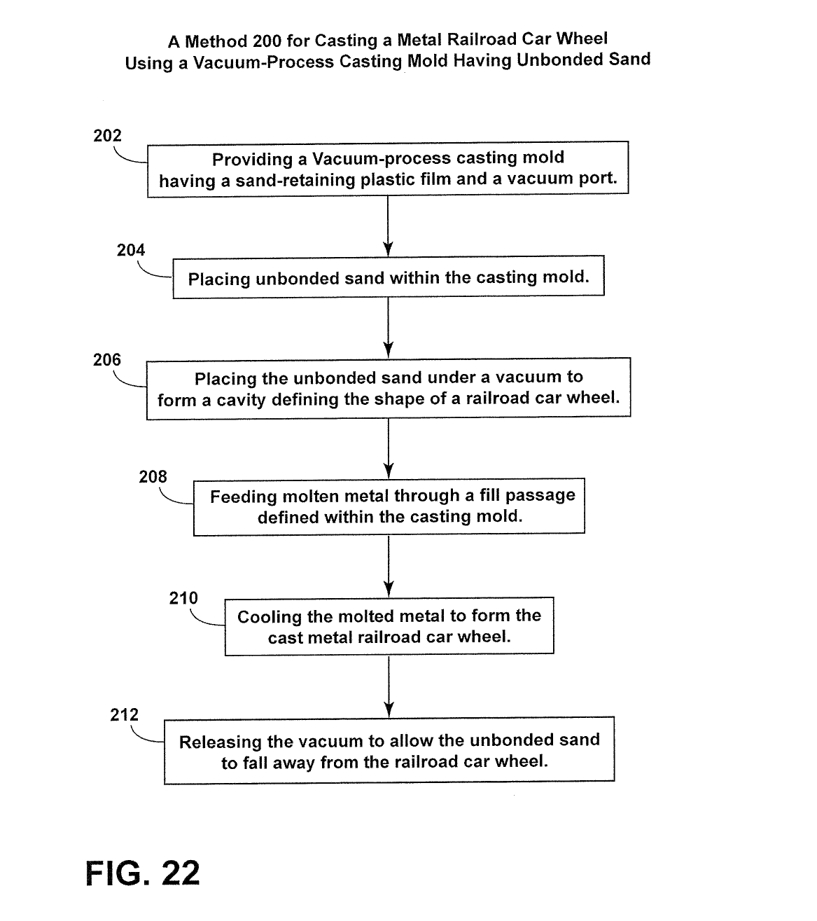

Referring now to FIG. 22, the process 200 for casting a cast metal railroad car wheel 50 comprises steps of providing a V-process casting mold 80 (step 202) with opposing halves 81,82 each partially filled with unbonded sand 83, 84 (step 204) and sand-retaining-plastic film 85, 86 and a vacuum application port 87, 88 connected to a vacuum source 90. When halves 81, 82 are positioned together with the unbonded sand 83, 84 held to shape in the form of sand mold 60 by vacuum (step 206) and by the film 85, 86, a shape of the cavity 91 can be maintained so that casting can accurately form the railroad car wheel 50. FIG. 18 illustrates a fill passage 94 in a top mold half 81, with a strainer/filter core 95 and a plastic one-piece riser form 96 forms an infeed/fill passage 97 over the hub section 51 of the cavity 91. Molten metal 70 is fed through the fill passage 97 (step 208) of the riser form 96, through the strainer/filter core 95, and into the cavity 91 (step 210). In the various embodiments, the strainer/filter core 95 can be made of various substantially heat-resistant materials that include, but are not limited to, ceramic, ceramic composites, glass-ceramic composites, and other similar heat-resistant materials. The molten metal 70 is cooled until it consistently and accurately maintains a shape defined by the cavity 91 (step 210). Thus, the cast metal railroad car wheel 50 is formed. The vacuum source 90 is then released, causing the unbonded sand 83, 84 to fall away from the cast metal railroad car wheel 50 (step 212) by the force of gravity or by mechanical or hand means as well. Notably, considerable time is saved since the sand does not need to be broken away. The loose particulate characteristics of sand provide a sand mold 60 that has no bond material that may require breakage or other manually intensive dismantling.

As illustrated in FIG. 21, the V-process casting allows the mold 80 to define a plurality of cavities 91, each cavity 91 being shaped to form a separate railroad car wheel 50 having a hub section 51, tread section 52, and web 53. The fill passage 97 in the illustrated multiple cavity vacuum-process casting mold 80 includes a down passage 97A, split lateral passages 97B and up passages 97C leading to hub sections 51 in two (or more) different wheels 50.

Referring now to FIGS. 10-11, one type of fill passage 97 can include a J-shaped ceramic tube 100 (sometimes called “ceramic tile gating”) for directing flow of infed molten metal 70 being motivated into the cavity 91. The molten metal 70 is fed down a vertical portion of the ceramic tube 100, then laterally, and then upwardly into the hub section 51 of the cavity 91. Notably, the ceramic tube 100 provides for better flow of molten material 70, with less defects in the cast railroad car wheel 50. More specifically, the use of ceramic tube 100 for ceramic tile gating and strainer cores eliminates erosion in the metal entry locations because the materials described above and used in these items can withstand the impact, heat, and abrasion experienced during V-process casting and during high speed pouring/flow of molten metal 70, which can be approximately 50 kilograms per second.

It is contemplated that infeeding molten metal 70 will be fed as fast as possible and at a relatively-low molten temperature through the fill passage 97 into the cavity 91. For example, it is contemplated that the molten metal 70 (i.e., the metal necessary to form a railroad car wheel 50) will be fed at a rate of at least about 50 kilograms per second (or slightly slower depending on requirements of an overall system, such as 45 kilograms per second) and fed at a temperature of less than about 2900 degrees Fahrenheit (or more preferably less than about 2850 degrees Fahrenheit, or most preferably at about 2825 degrees Fahrenheit). There is a possibility that the temperature of the molten metal 70 could even be poured lower than about 2825 degrees Fahrenheit. Notably, a temperature of approximately 2825 degrees Fahrenheit is only about 95 degrees Fahrenheit above the solidification temperature of molten metals 70 typically used in casting railroad car wheels 50 (2730 degrees Fahrenheit). It is also contemplated that the molten metal 70 could be fed at a temperature of less than 2825 degrees Fahrenheit. In various embodiments, the molten metal 70 can be fed at a temperature of approximately 60 degrees Fahrenheit above the solidification temperature of molten metals 70, or about 2790 degrees Fahrenheit. This closeness of the temperature of the inflow molten metal 70 to solidification temperature results in a considerably shorter cooling period. Such a short cooling period reduces cooling times substantially sooner than a conventional “similar” graphite molding process. For example, V-process casting can form and release the vacuum source 90 in a time period of five minutes, which not only speeds the overall cycle time, but also allows the wheel 50 freedom to cool and shrink without restriction, thereby reducing internal stress. This fast inflow rate of the molten metal 70 and decreased temperature of the molten metal 70 is made possible using sand molding technology, such as that used in V-process molding. As discussed earlier, use of sand molds 60 is very contrary to the traditional thinking of experts in the casting industry for railroad wheels which uses only graphite moldings, where inflow temperatures must be higher, when compared to V-process casting temperatures, and cooling times can be 20 minutes or longer. However, the disclosed V-process casting works well since faster inflow speeds of the molten metal 70 cause the molten metal 70 to reach a desired location within the cavity 91 before the fill passages 94 begin to breakdown and/or distort (as in graphite molding). Also, the molten metal 70 can be moved to reach its desired destination in the mold cavity 91 before cooling starts to set in that might cause distortion near the end-filled stage of filling a casting cavity 91.

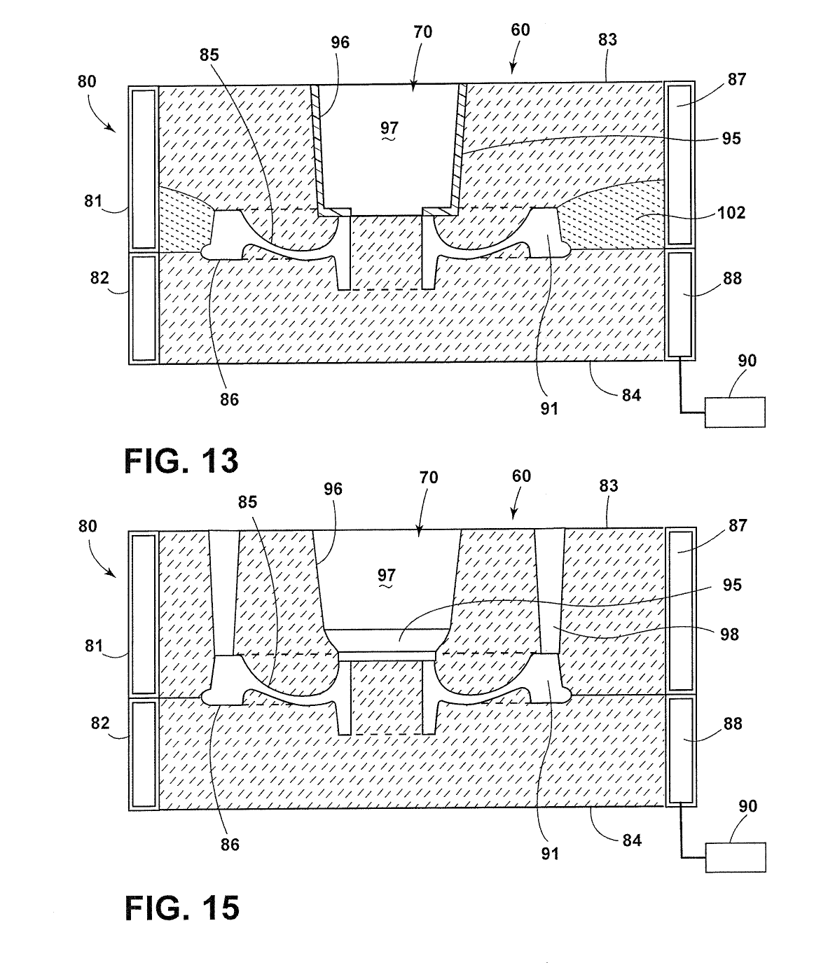

Referring now to FIGS. 12 and 13, a fill passage 97 is provided in one of the opposing halves 81, 82 (the top half 81 includes the fill passage 97 in FIGS. 12 and 13) that includes a vent-forming material 102 touching an outer end of the tread section 52 of the cavity 91 to allow air to escape as the molten metal 70 fills the cavity 91, thereby preventing air pockets. The vent-forming material 102 can be any one of various materials that can include, but are not limited by, zircon or chromite media or other similar vent-forming material. Persons skilled in the art of casting and those skilled in existing alternate V-process casting methods will appreciate and know how to use and place the vent-forming material 102, such that a detailed explanation is not required in this document. Standard silica mold does not promote the rapid solidification of the wheel tread and feed risers are needed to prevent air pockets due to shrinkage during cooling. Accordingly, structures such as localized chilling with materials (i.e., zircon, chromite, or metal alloys) having high thermal conductivity can solve this by promoting directional solidification. Notably, the V-process allows pouring the molten metal 70 faster and at lower temperatures. These V-process characteristics also can advantageously affect directional solidification if properly controlled.

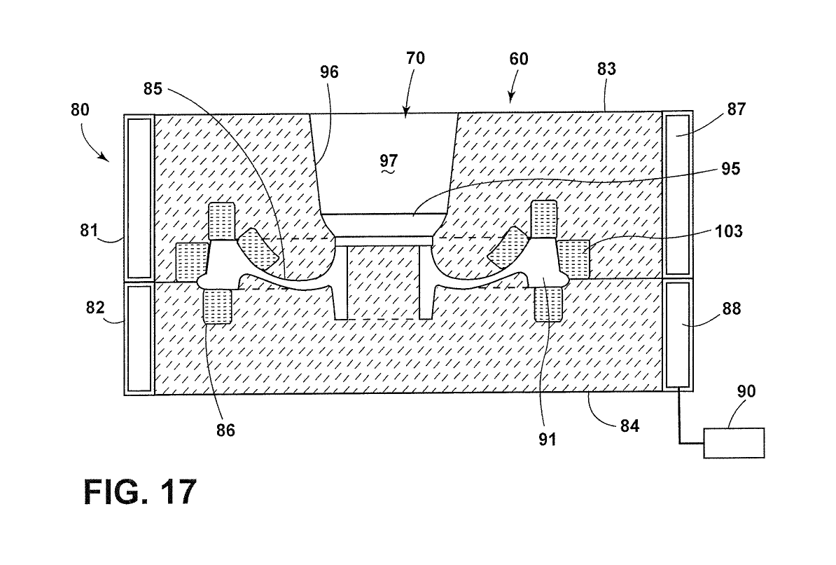

Referring again to FIGS. 12 and 13, the vent-forming material 102 can also double as a cast-cooling-accelerator material. Since it touches the outer end of the tread section 52 of the cavity 91, it acts to cause directional cooling, with initial cooling starting at the outer radial portion of the wheel 50. Steel or iron chills 103 (shown in FIGS. 16 and 17) can be used to force chill on the tread section 52. The term “directional cooling” will be understood by persons skilled in the art, and its advantages will be understood by skilled persons since it provides structural and stress-related benefits in the final cast railroad car wheel 50.

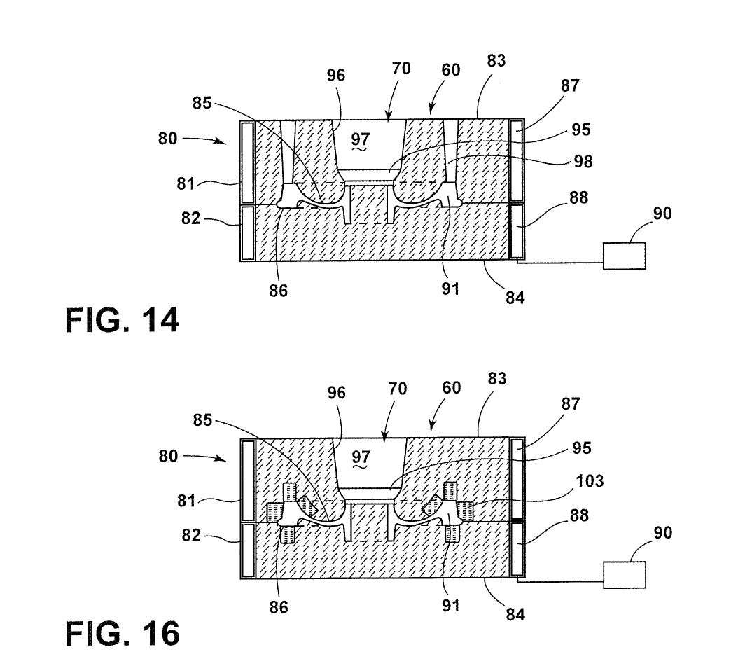

Persons skilled in the art will recognize a variety of additional modifications are possible, while still staying within a scope of the present invention. For example, as illustrated in FIGS. 14 and 15, a vent 98 can be installed proximate the tread section 52 of the cavity 91, instead of using risers 96. It is contemplated that many different designs of fill passages 94 and chillers 103 can be arranged, depending on particular V-process molding machinery and functional requirements.

The present innovation using V-process technology as described herein includes novel aspects in at least the following areas: 1) a new wheel cross section with a single curve or “single-sweep” rib, 2) first railroad car wheel cast using V-process casting, 3) first process where multiple cavities can be cast in a single casting operation, 4) first V-process casting method using A) ceramic infill tile (tubes), B) emphasizing pour casting fast and with “cold” molten material, C) special venting system for V-process, E) plastic risers, F) cluster handling system, G) providing 65%+ yield (or more preferably 80% yield, or most likely 85% yield if properly controlled) on casting wheels, H) one sand type for cores and molding. The present innovation is believed to provide molding times that are faster, more efficient (such as through use of multiple cavities in a single mold), and with far greater yield (i.e. greatly reduced scrap and defective castings) such as 65% or greater yield (or more preferably 80% yield, or most likely 85% yield if properly controlled) on cast railroad wheels 50.

It is contemplated that any of the individual features of the embodiments of the railroad car wheels 50 and 50A as well as the various steps and features of the embodiments of the V-process casting can be combined with any other feature or features of the various embodiments of the railroad car wheels 50, 50A and the V-process casting steps and features.

It is to be understood that variations and modifications can be made on the aforementioned structure without departing from the concepts of the present invention, and further it is to be understood that such concepts are intended to be covered by the following claims unless these claims by their language expressly state otherwise.

1-37. (canceled)

38. A process for casting multiple cast metal railroad car wheels simultaneously, comprising steps of:
providing a casting mold with opposing halves each at least partially filled with sand and that, when positioned together with the sand, define a plurality of cavities each shaped to form a railroad car wheel having a hub section with an axle bore, a tread section with an axially-extending edge flange, and an uninterrupted annular web extending between and supporting the tread section on the hub section;
providing a fill passage leading into each of the cavities for communicating infed molten metal;
infeeding molten metal through the fill passages and through a filter into the cavities; and
cooling the molten metal to simultaneously form a plurality of cast metal railroad car wheels.

39. The process of claim 38, wherein the process for casting comprises a vacuum casting mold process, commonly called V-process molding, and includes sand disposed within a sand-retaining-plastic film and a vacuum application port, and the sand is unbonded sand, and wherein after the plurality of cast metal railroad car wheels are formed, a vacuum is released to cause the unbonded sand to fall away from the plurality of cast metal railroad car wheels.

40. The process of claim 38, wherein the infed molten metal is fed through the fill passages at a temperature of less than about 2850 degrees Fahrenheit.

41. The process of claim 38, wherein the temperature is less than about 2800 degrees Fahrenheit.

42. The process of claim 38, wherein the molten metal is fed at a rate of at least about 50 kilograms per second.

43. The process of claim 38, wherein the molten metal is fed at a temperature that is less than about 150 degrees Fahrenheit from the molten metal's solidification temperature.

44. The process of claim 38, wherein the step of releasing the vacuum causes the unbonded silica sand to fall away solely by force of gravity.

45. A process for casting a railroad car wheel comprising steps of:
providing a V-process casting mold including unbonded sand defining at least one cavity shaped to form a railroad car wheel;
filling the cavity with molten metal; and
cooling the molten metal to thus form a metal railroad car wheel casting.

46. The process of claim 45, wherein the mold includes a plurality of cavities.

47. The process of claim 45, wherein the molten metal has a temperature of less than about 2800 degrees Fahrenheit.

48. The process of claim 45, wherein the molten metal is fed at a rate of at least about 50 kilograms per second.

49. The process of claim 45, wherein the molten metal is fed at a temperature that is less than about 150 degrees Fahrenheit from the molten metal's solidification temperature.

50. The process of claim 45, wherein the mold includes a fill passage positioned over a hub section of the wheel, and includes a tube-defining plastic riser leading to a filter that strains infed molten metal being motivated through the plastic riser into the cavity.

51. The process of claim 45, wherein the mold includes a ceramic tube defining at least a portion of a fill passage into the wheel.

52. The process of claim 45, wherein the unbonded sand defines the at least one cavity through the application of a vacuum to the V-process casting mold having the unbonded sand.

53. The process of claim 52, wherein the V-process casting mold includes opposing halves each including the unbonded sand adjacent a sand-retaining-plastic film having a vacuum application port, wherein the opposing halves, when positioned together with the unbonded sand held to shape by application of the vacuum to the film, define the at least one cavity shaped to form at least one railroad car wheel, each at least one railroad car wheel having a hub section with an axle bore, a tread section with an axially-extending edge flange, and an uninterrupted annular web extending between and supporting the tread section on the hub section.

54. The process of claim 53, further comprising the step of:
releasing the vacuum to cause the unbonded sand to fall away by gravity from the metal railroad car wheel casting.

55. A cast metal railroad car wheel comprising:
a hub section with axle bore;
a tread section with an axially-extending edge flange; and
an uninterrupted annular web extending between and supporting the tread section on the hub section, the web including opposing disk-shaped surfaces, at least one of the disk-shaped surfaces, when cross-sectioned through the hub and tread sections, defining a cross-sectional shape having a radius of less than 35 millimeters.

56. The cast metal railroad car wheel of claim 55, wherein the radius is less than about 25 millimeters.

57. The cast metal railroad car wheel of claim 55, wherein the radius is less than about 15 millimeters.
